(19) United States
(12) Patent Application Publication
(10) Pub. No.: US 2015/0206465 A1
(43) Pub. Date: Jul. 23, 2015

(54) FLEXIBLE EXPRESSION DISPLAY DEVICE

(71) Applicant: SUMITOMO RIKO COMPANY LIMITED, Aichi-ken (JP)

(72) Inventors: Hitoshi YOSHIKAWA, Aichi-ken (JP); Jun KOBAYASHI, Aichi-ken (JP); Shijie GUO, Aichi-ken (JP)

(73) Assignee: SUMITOMO RIKO COMPANY LIMITED, Aichi-ken (JP)

(21) Appl. No.: 14/672,621

(22) Filed: Mar. 30, 2015

Related U.S. Application Data
(63) Continuation of application No. PCT/JP2013/083603, filed on Dec. 16, 2013.

(30) Foreign Application Priority Data
Dec. 19, 2012 (JP) 2012-276765

(51) Int. Cl. G09F 19/08

(52) U.S. Cl. CPC G09F 19/08

(57) ABSTRACT

An expression display device includes an electrostrictive element having a stretched dielectric layer, and electrodes disposed with the dielectric layer interposed therebetween. The dielectric layer has a crosslinked material layer made of a three-dimensional crosslinked material synthesized from a rubber polymer and a metal alkoxide compound or a compound having a hydrosilyl group. The electrodes contain an elastomer and a conductive material. The expression display device displays a facial expression as the dielectric layer extends and contracts according to a voltage that is applied between the electrodes.

### TECHNICAL FIELD

The present invention relates to flexible expression display devices that display facial expressions of a robot etc.

### BACKGROUND ART

Nursing care robots and robots intended to communicate with humans have been increasingly developed. In order to introduce these robots into daily life, it is necessary to enhance communication ability of the robots so humans can have an affinity with them. It is therefore important for the robots to be able to express various emotions on their faces.

For example, Patent Document 1 describes a communication robot including a flexible panel that displays an image of a face, a plurality of air pads that are disposed on the back surface of the flexible panel, and an air supply unit that supplies air to the air pads. Patent Documents 2, 3 describe expression display devices using an electrostrictive element that extends and contracts according to the magnitude of an applied voltage.

### RELATED ART DOCUMENTS

### Patent Documents

[Patent Document 1] Japanese Patent Application Publication No. 2010-167002 (JP 2010-167002 A)
[Patent Document 2] U.S. Pat. No. 6,586,859
[Patent Document 3] Japanese Patent Application Publication No. 2003-225470 (JP 2003-225470 A)

### SUMMARY OF THE INVENTION

### Problem to be Solved by the Invention

The communication robot described in Patent Document 1 displays an image of a face on the flexible panel. Parts of the surface of the flexible panel, more specifically the surface of the face, are pushed out or pulled in by varying the amount of air supply into the individual air pads. However, a facial expression is merely selected from prestored image data. The communication robot can therefore display only a limited number of expressions, and cannot make natural expressions of a human or animal. Moreover, since air needs to be supplied to or discharged from the air pads for different expressions, the issue of sounds that are generated when supplying or discharging air to or from the air pads cannot be ignored.

The expression display devices of Patent Documents 2, 3 use an electrostrictive element. The electrostrictive element is formed by a dielectric layer and a pair of electrodes having the dielectric layer interposed therebetween. For example, increasing an applied voltage between the electrodes increases electrostatic attraction between the electrodes. The dielectric layer interposed between the electrodes is therefore compressed in the thickness direction, and the thickness of the dielectric layer is reduced. As the thickness of the dielectric layer decreases, the dielectric layer is extended in a direction parallel to the electrode surfaces accordingly. On the other hand, reducing the applied voltage between the electrodes reduces the electrostatic attraction between the electrodes. The compressive force that is applied to the dielectric layer in the thickness direction therefore decreases, and the thickness of the dielectric layer increases due to its elastic restoring force. As the thickness of the dielectric layer increases, the dielectric layer contracts in the direction parallel to the electrode surfaces accordingly. These expression display devices thus change expressions by moving parts of a face by using extension and contraction of the dielectric layer which occur according to a change in applied voltage.

However, in the expression display devices of Patent Documents 2, 3, commercially available acrylic rubber or silicone rubber is used for the dielectric layer forming the electrostrictive element. In order to cause such rubber to extend and contract to such an extent that the facial expression changes, a voltage as high as 300 V or more need be applied with the rubber being stretched to 100% or more. The dielectric layer therefore creeps significantly. Accordingly, the expression display devices of Patent Documents 2, 3 cannot repeatedly display certain expressions for a long period of time. Moreover, the life of the device is short as the electrostrictive element is not durable enough.

The present invention was developed in view of the above situations, and it is an object of the present invention to provide a durable flexible expression display device capable of making natural expressions by making a movement similar to that of mimic muscles.

### Means for Solving the Problem

(1) A flexible expression display device according to the present invention is characterized by including: an electrostrictive element having a stretched dielectric layer, and electrodes disposed with the dielectric layer interposed therebetween, wherein the dielectric layer has a crosslinked material layer made of a three-dimensional crosslinked material synthesized from a rubber polymer and a metal alkoxide compound or a compound having a hydrosilyl group, the electrodes contain an elastomer and a conductive material, and the flexible expression display device displays a facial expression as the dielectric layer extends and contracts according to a voltage that is applied between the electrodes.

The flexible expression display device of the present invention includes the electrostrictive element, and displays a facial expression by using extension and contraction of the dielectric layer which occur according to a change in applied voltage. Sound that is generated during driving is low as compared to devices that require supply and discharge of air. The flexible expression display device of the present invention is formed by using mainly an elastomer material. The flexible expression display device of the present invention therefore has a feel close to a living body, and is characterized by being light and thin. Since the flexible expression display device of the present invention can make a movement similar to that of mimic muscles, it can make natural expressions of a human or animal. A single electrostrictive element or a plurality of electrostrictive elements may be disposed over a part of or an entire face.

The dielectric layer forming the electrostrictive element has the crosslinked material layer made of the three-dimensional crosslinked material synthesized from the rubber polymer and the metal alkoxide compound or the compound having the hydrosilyl group. The three-dimensional crosslinked material is produced by an uncrosslinked rubber polymer being crosslinked with a metal alkoxide compound or a compound having a hydrosilyl group. Alternatively, the three-dimensional crosslinked material is produced by an uncrosslinked or crosslinked rubber polymer penetrating a crosslinked metal alkoxide compound. That is, in the former case, an uncrosslinked rubber polymer is crosslinked with a metal alkoxide compound or a compound having a hydrosilyl group to produce the three-dimensional crosslinked material. In the latter case, an uncrosslinked or crosslinked rubber polymer penetrates a crosslinked metal alkoxide compound to produce the three-dimensional crosslinked material.

The three-dimensional crosslinked material contains an inorganic substance that is produced by a reaction between the rubber polymer and the metal alkoxide compound or the compound having the hydrosilyl group. Since the inorganic substance blocks a flow of electrons, the crosslinked material layer has high insulation properties. Moreover, the crosslinked material layer has high strength as it contains the inorganic substance. Accordingly, the crosslinked material layer is less likely to creep and has high durability. Since the dielectric layer includes such a crosslinked material layer, the dielectric layer has high strength and also has high resistance to dielectric breakdown and high resistance to creep. The flexible expression display device of the present invention can therefore repeatedly display certain expressions for a long period of time. Moreover, since the electrostrictive element has high durability, the life of the device is long.

The dielectric layer may have a single layer structure comprised only of the crosslinked material layer or a multi-layer structure comprised of a stack of the crosslinked material layer and at least one other layer(s). Examples of the other layer(s) include various layers such as an elastomer layer, a high resistance layer containing an elastomer and insulating particles, an ion component-containing layer containing an elastomer and an ion component, and a semiconductor-containing layer containing an elastomer and a semiconductor.

The electrodes forming the electrostrictive element contain the elastomer and the conductive material. Since the elastomer is used as a matrix material of the electrodes, the electrodes are flexible and can extend and contract. The entire flexible expression display device is therefore flexible. Since the electrodes extend and contract according to extension and contraction of the dielectric layer, movement of the dielectric layer is less likely to be restricted by the electrodes. A desired displacement amount can therefore be easily obtained.

(2) Preferably, in the configuration of (1), the dielectric layer is disposed in a stretched state over a part of or an entire face, the electrodes are comprised of front electrodes arranged in a plurality of lines on a front surface of the dielectric layer and back electrodes arranged in a plurality of lines on a back surface of the dielectric layer, and the front electrodes cross the back electrodes as viewed in a front-back direction to form a plurality of drive units.

According to this configuration, the electrostrictive element is disposed over a part of or the entire face. In the electrostrictive element, the electrodes are comprised of the plurality of front electrodes disposed on the front surface of the dielectric layer and the plurality of back electrodes disposed on the back surface of the dielectric layer. The drive units (voltage application portions) are disposed by using the portions where the front electrodes cross the back electrodes. It is therefore not necessary to separately dispose electrodes for the individual drive units. That is, even if the number of electrodes is small, the drive units can be disposed so as to be dispersed on the entire dielectric layer. The plurality of drive units can therefore be easily disposed so as to correspond to different parts of the face such as a forehead, eyebrows, eyes, cheeks, and a mouth. Moreover, each part of the face can be moved by causing the dielectric layer corresponding to that part of the face to extend and contract by controlling a voltage that is applied to the drive units. The expression display device of the present invention can thus display various expressions.

(3) Preferably, in the configuration of (2), a degree of stretching of the dielectric layer varies in each part of the face.

If the same voltage is applied to dielectric layers with different degrees of stretching, the dielectric layer with a larger degree of stretching is extended to a greater extent. According to this configuration, the displacement amount according to movement of each part of the face can be implemented by merely varying the degree of stretching of the dielectric layer.

(4) Preferably, in the configuration of (1), at least one electrostrictive element is disposed so as to correspond to a part of a face.

According to this configuration, the electrostrictive element is placed at each part of the face which is to be moved, such as eyes and a mouth. For example, in the case where only the mouth is to be moved, only one electrostrictive element need be placed at the position corresponding to the mouth. In the case where only the eyes are to be moved, one electrostrictive element need be placed at each of the positions corresponding to the eyes. According to this configuration, the electrostrictive element need be placed only at those parts which are to be moved. This can simplify the configuration of the expression display device. Moreover, the displacement amount can be easily adjusted for each part of the face. The expression display device can therefore display various expressions.

(5) Preferably, in the configuration of (4), a plurality of the electrostrictive elements are disposed so as to correspond to parts of the face, and the degree of stretching of the dielectric layer varies in each electrostrictive element.

As described above with respect to the configuration of (3), the displacement amount in response to voltage application can be varied by varying the degree of stretching of the dielectric layer. According to this configuration, the displacement amount according to movement of each part of the face can therefore be implemented by merely varying the degree of stretching of the dielectric layer.

(6) Preferably, in the configuration of any one of (1) to (5), the degree of stretching of the dielectric layer varies between two directions perpendicular to each other in a same plane.

How the stretched dielectric layer is extended in response to voltage application is determined by the balance between a compressive force due to electrostatic attraction between the electrodes and a tensile force in a portion where no electrode is placed. The larger the degree of stretching is, the larger the tensile force in that direction is. However, since the elastic modulus of the dielectric layer also varies, extension of the dielectric layer can be controlled. For example, in the case where the dielectric layer in the shape of a rectangular sheet is stretched so as to have a smaller degree of stretching in the longitudinal direction than in the lateral direction, and the elastic modulus of the dielectric layer is smaller in the longitudinal direction, in which the degree of stretching is smaller, than in the lateral direction, the compressive force from the electrodes increases in response to voltage application, and the dielectric layer is preferentially extended in the longitudinal direction in which the elastic modulus is smaller.

According to this configuration, the displacement amount of the dielectric layer can be varied between the two directions perpendicular to each other in the same plane. Accordingly, as compared to the case where the dielectric layer extends and contracts uniformly, the dielectric layer can be made to move in a manner closer to that in which each part of the face moves. As a result, the expression display device of the present invention can display more natural expressions.

(7) Preferably, in the configuration of any one of (1) to (6), the flexible expression display device further includes: a cover layer that covers the electrostrictive element and that can extend and contract.

The cover layer can extend and contract. The cover layer therefore extends and contracts according to extension and contraction of the dielectric layer. For example, expressions can be easily made by drawing the parts of the face such as eyes and mouth on the cover layer and causing the cover layer to extend and contract according to extension and contraction of the dielectric layer. Moreover, the surface of the cover layer (the surface of the expression display device) can be made to look more like the skin of a human or animal by coloring the cover layer. The expression display device of the present invention can therefore make more real expressions. Moreover, the use of the cover layer made of an insulating material can ensure insulation properties against the electrodes, which improves safety.

(8) Preferably, in the configuration of any one of (1) to (7), the voltage that is applied between the electrodes is 1,500 V or less.

As described above with respect to the configuration of (1), the crosslinked material layer has high insulation properties and high strength. The thickness of the crosslinked material layer can therefore be reduced. That is, the thickness of the dielectric layer can be reduced. The electrostrictive element can therefore be driven at a relatively low voltage of 1,500 V or less. A more preferable applied voltage is 1,300 V or less, and more preferably 1,000 V or less.

(9) Preferably, in the configuration of any one of (1) to (8), the rubber polymer is one or more selected from nitrile rubber, hydrogenated nitrile rubber, acrylic rubber, urethane rubber, fluororubber, fluorosilicone rubber, chlorosulfonated polyethylene rubber, chloroprene rubber, an ethylene-vinyl acetate copolymer, chlorinated polyethylene, hydrin rubber, and polyether rubber.

These rubber polymers have relatively high dielectric constants. According to this configuration, a large displacement amount of the dielectric layer can therefore be implemented even if the applied voltage is relatively low. In particular, hydrogenated nitrile rubber, acrylic rubber, urethane rubber, and polyether rubber are preferable in terms of the balance between the dielectric constant and the resistance to dielectric breakdown, strength, and crosslinkability, etc. It is desirable that the rubber polymer have one or more functional groups selected from a carboxyl group (—COOH), a hydroxyl group (—OH), and an amino group (—NH). These functional groups serve as crosslinking sites for crosslinking with the metal alkoxide compound.

(10) Preferably, in the configuration of any one of (1) to (9), the crosslinked material layer is made of the three-dimensional crosslinked material synthesized from the rubber polymer and the metal alkoxide compound.

The use of the metal alkoxide compound can improve the resistance to creep and resistance to dielectric breakdown of the three-dimensional crosslinked material layer as compared to the case of using the compound having the hydrosilyl group.

(11) Preferably, in the configuration of any one of (1) to (10), the metal alkoxide compound contains one or more metals selected from titanium, zirconium, and aluminum.

The metal alkoxide compound containing one or more metals selected from titanium, zirconium, and aluminum has satisfactory reactivity with the rubber polymer. Specifically, tetra-n-butoxy titanium, tetra-n-butoxy zirconium, tetra-n-butoxy silane, acetoalkoxyaluminum diisopropylate, tetra-i-propoxy titanium, tetraethoxysilane, etc. are preferable.

(12) Preferably, in the configuration of any one of (1) to (9), the compound having the hydrosilyl group further has one or more of a phenyl group, an aryl group, and an alkyl group.

In the case where the compound having the hydrosilyl group further has any one of the phenyl group, the aryl group, and the alkyl group, the compound having the hydrosilyl group has improved compatibility with the rubber polymer. Crosslinking can therefore be performed efficiently.

### BRIEF DESCRIPTION OF THE DRAWINGS

FIG. 1 is a front transparent view of an expression display device according to a first embodiment.

FIG. 2 is a front view of a cover layer in the expression display device.

FIG. 3 is a front transparent view of an electrostrictive element in the expression display device.

FIG. 4 is a front view of a frame in the expression display device.

FIG. 5 is a front transparent view of an expression display device according to a second embodiment.

FIG. 6 is a front view of a cover layer in the expression display device.

FIG. 7 is a front transparent view of an electrostrictive element in the expression display device.

FIG. 8 is a front view of a base material in the expression display device.

FIG. 9 is a top view of the electrostrictive element used in the evaluation experiments of examples.

FIG. 10 is a sectional view taken along line X-X in FIG. 9.

### DESCRIPTION OF THE REFERENCE NUMERALS

1: Expression Display Device
10: Frame
11: Peripheral Frame
12: Partition Frame
13: Base Material
20: Electrostrictive Element
21: Dielectric Layer
30: Cover Layer
40, 41, 42: Electrostrictive Element
120, 121, 122: Region
400, 410, 420: Dielectric Layer
401, 411, 421: Front Electrode
402, 412, 422: Back Electrode
5: Electrostrictive Element
50: Dielectric Layer
51a, 50b: Electrode
52: Power Supply
53: Displacement Meter
510a, 510b: Terminal Portion
530: Marker
01X to 05X: Front Electrode
01Y to 05Y: Back Electrode
A0101 to A0504: Drive Unit

### MODES FOR CARRYING OUT THE INVENTION

Embodiments of a flexible expression display device of the present invention will be described below.

### First Embodiment

### Configuration of Expression Display Device

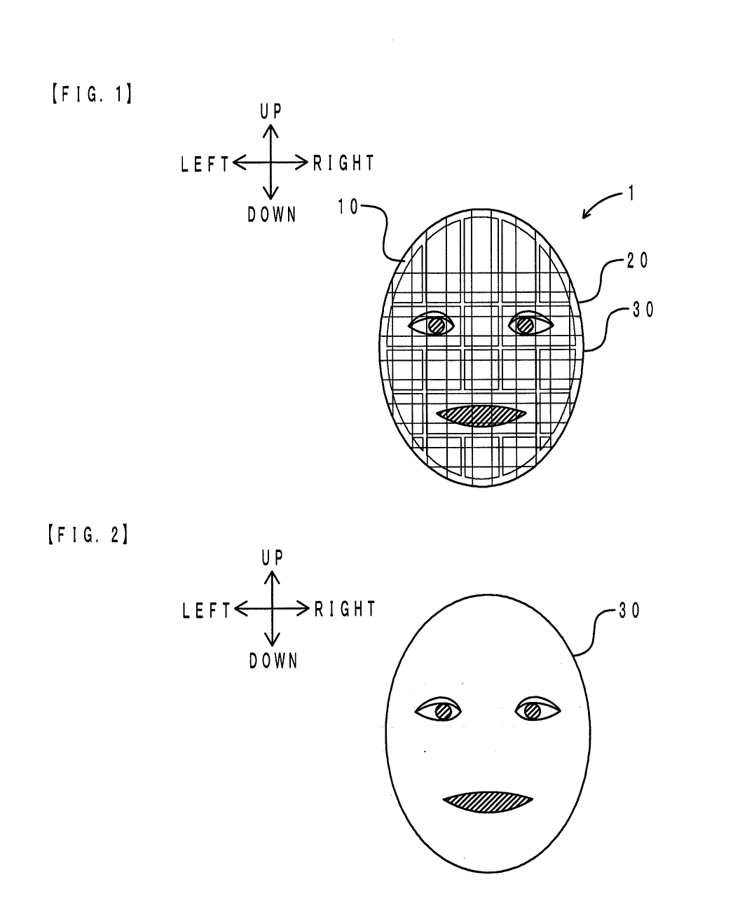

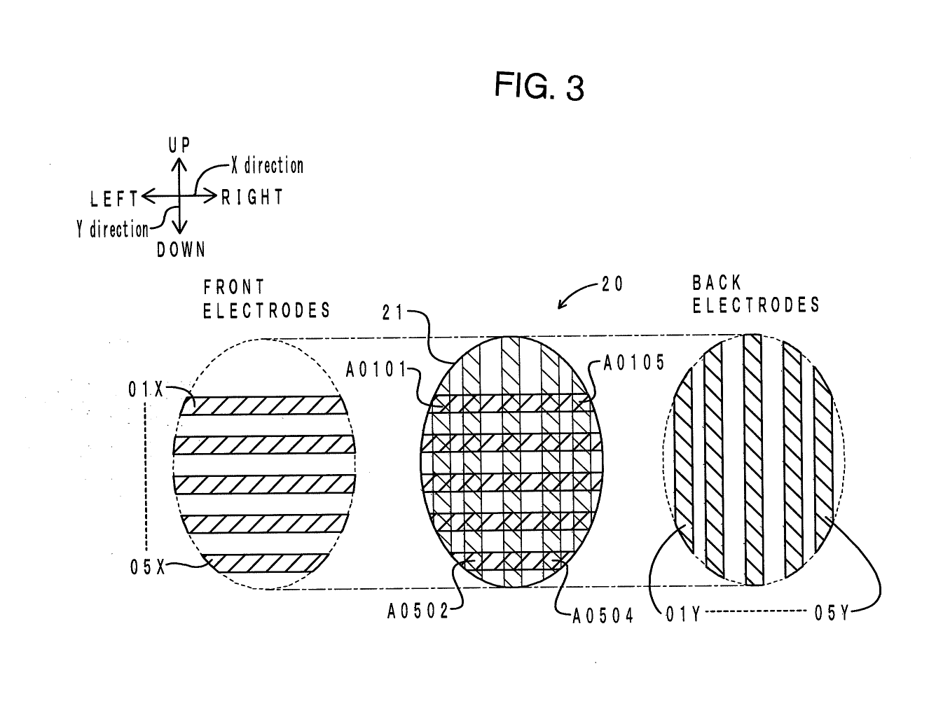

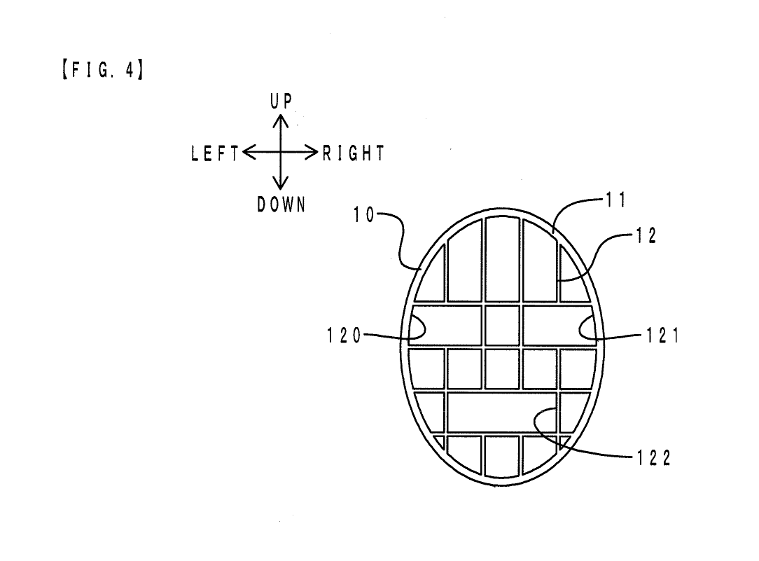

First, the configuration of an expression display device according to the present embodiment will be described. FIG. 1 is a front transparent view of the expression display device of the present embodiment. FIGS. 2 to 4 are plan views sequentially showing members of the expression display device from the front side. That is, FIG. 2 is a front view of a cover layer. FIG. 3 is a front transparent view of an electrostrictive element. FIG. 4 is a front view of a frame. In FIGS. 1 and 3, the members shown transparently are shown by thin lines. Front electrodes and back electrodes are shown hatched in FIG. 3. The front surface of the expression display device 1 is a smoothly curved surface having a convex shape. However, for convenience of description, the front surface of the expression display device 1 is shown as a flat surface in FIGS. 1 to 4. As shown in FIGS. 1 to 4, the expression display device 1 includes a frame 10, an electrostrictive element 20, and a cover layer 30.

As shown in FIG. 4, the frame 10 is made of a resin and is in the shape of an elliptical frame. The frame 10 is disposed on a face part of a humanoid robot (not shown). The frame 10 has a peripheral frame 11 and a partition frame 12. The partition frame 12 is disposed in a grid pattern inside the peripheral frame 11 so as to divide the entire face into a plurality of regions.

The electrostrictive element 20 is disposed so as to cover the front surface of the frame 10. As shown in FIG. 3, the electrostrictive element 20 has a dielectric layer 21, front electrodes 01X to 05X, and back electrodes 01Y to 05Y.

The dielectric layer 21 is in the shape of an elliptical sheet. The dielectric layer 21 has a thickness of 15 μm. The dielectric layer 21 is made of a three-dimensional crosslinked material produced by crosslinking a rubber polymer of carboxyl group-containing nitrile rubber with tetra-n-butoxy titanium (metal alkoxide compound). That is, the dielectric layer 21 is comprised of only a crosslinked material layer. The dielectric layer 21 is fixed in a stretched state to the peripheral frame 11 and the partition frame 12 of the frame 10. The degree of stretching of the dielectric layer 21 is set for each region defined by the peripheral frame 11 and the partition frame 12 or by only the partition frame 12. Specifically, the degree of stretching of the dielectric layer 21 in regions 120, 121, 122 (see FIG. 4) corresponding to the positions of eyes and a mouth is 100% in the up-down direction and 200% in the left-right direction. The degree of stretching of the dielectric layer 21 in the other regions is 50% in both the up-down and left-right directions.

The front electrodes 01X to 05X are formed on the front surface (front side) of the dielectric layer 21. The front electrodes 01X to 05X contain acrylic rubber and carbon black. Each of the front electrodes 01X to 05X is in the shape of a strip. The front electrodes 01X to 05X extend in the X direction (left-right direction). The front electrodes 01X to 05X are disposed at predetermined intervals in the Y direction (up-down direction) so as to be substantially parallel to each other. Each of the front electrodes 01X to 05X is connected to a control unit (not shown) via a wire (not shown).

The back electrodes 01Y to 05Y are formed on the rear surface (back side) of the dielectric layer 21. The back electrodes 01Y to 05Y contain acrylic rubber and carbon black. Each of the back electrodes 01Y to 05Y is in the shape of a strip. The back electrodes 01Y to 05Y extend in the Y direction (up-down direction). The back electrodes 01Y to 05Y are disposed at predetermined intervals in the X direction (left-right direction) so as to be substantially parallel to each other. Each of the back electrodes 01Y to 05Y is connected to the control unit (not shown) via a wire (not shown).

The front electrodes 01X to 05X and the back electrodes 01Y to 05Y are formed by a screen printing method. Drive units A0101 to A0504 (there is no A0501) are disposed in the portions where the front electrodes 01X to 05X overlap the back electrodes 01Y to 05Y as viewed in the front-rear direction (front-back direction). Each of the drive units A0101 to A0504 includes a part of a corresponding one of the front electrodes 01X to 05X, a part of a corresponding one of the back electrodes 01Y to 05Y, and a part of the dielectric layer 21. A total of 23 (=5×5−2) drive units A0101 to A0504 are provided. The drive units A0101 to A0504 are disposed at substantially regular intervals on the substantially entire surface of the dielectric layer 21. In the reference character “A◯◯ΔΔ” of the drive units, the first two digits “◯◯” correspond to the front electrodes 01X to 05X, and the last two digits “ΔΔ” correspond to the back electrodes 01Y to 05Y.

As shown in FIG. 2, the cover layer 30 is disposed so as to cover the front surface of the electrostrictive element 20. The cover layer 30 is bonded to the front surface of the electrostrictive element 20. The cover layer 30 is made of silicone rubber colored pale orange, and is in the shape of an elliptical sheet. The cover layer 30 has a thickness of 20 μm. Eyes and a mouth have been drawn on the front surface of the cover layer 30.

[Movement of Expression Display Device]

Movement of the expression display device 1 of the present embodiment will be described below. For example, in the case of displaying a joyful expression, a voltage of 1,000 V is applied to the front electrodes 02X, 04X and the back electrodes 02X to 04X. The voltage is thus applied to the drive units placed at the positions of the eyes and the mouth. The dielectric layer 21 in these driving units is compressed in the front-rear direction, and is extended in a planar direction. The degree of stretching of the dielectric layer 21 in the regions 120, 121, 122 corresponding to the positions of the eyes and the mouth is 100% in the up-down direction and 200% in the left-right direction. The dielectric layer 21 is therefore extended to a greater extent in the direction in which the degree of stretching is smaller, namely in the up-down direction. As the dielectric layer 21 is extended, the cover layer 30 corresponding to the same regions is also extended accordingly. The eyes and mouth drawn on the cover layer 30 thus become bigger. A joyful expression is displayed in this manner.

[Functions and Effects]

Functions and effects of the expression display device 1 of the present embodiment will be described below. The expression display device 1 of the present embodiment includes the electrostrictive element 20 and displays a facial expression by using extension and contraction of the dielectric layer 21 which occur according to a change in applied voltage. Sound that is generated during driving is low as compared to devices that require supply and discharge of air. The expression display device 1 is formed by using mainly an elastomer material. The expression display device 1 is therefore light, thin, and flexible, and has a feel close to a living body. Since the expression display device 1 can make a movement similar to that of mimic muscles, it can make natural expressions of a human.

According to the expression display device 1 of the present embodiment, only one electrostrictive element 20 need be placed over the entire face. The drive units A0101 to A0504 can be disposed by using the portions where the front electrodes 01X to 05X perpendicularly cross the back electrodes 01Y to 05Y. It is therefore not necessary to separately dispose electrodes for the individual drive units A0101 to A0504. That is, even if the number of electrodes is small, the drive units A0101 to A0504 can be disposed so as to be dispersed on the entire dielectric layer 21. The drive units A0101 to A0504 can therefore be easily disposed at the positions corresponding to a forehead, eyes, cheeks, and a mouth. Moreover, the forehead, eyes, cheeks, and mouth can be moved by controlling a voltage that is applied to the drive units A0101 to A0504. The expression display device 1 of the present embodiment can thus display various expressions.

According to the expression display device 1 of the present embodiment, the degree of stretching of the dielectric layer 21 varies between the regions 120, 121, 122 corresponding to the positions of the eyes and mouth and the other regions. The displacement amount according to the movement of the parts of the face can therefore be implemented even if the same voltage is applied. The degree of stretching of the dielectric layer 21 in the regions 120, 121, 122 corresponding to the positions of the eyes and mouth varies between the up-down direction and the left-right direction. The dielectric layer 21 in these regions is therefore preferentially extended in the direction in which the degree of stretching is smaller (up-down direction). The dielectric layer 21 can thus be made to extend and contract in a manner closer to that in which each part of the face moves. The expression display device 1 can therefore display more natural expressions.

The dielectric layer 21 is made of a three-dimensional crosslinked material produced by crosslinking a rubber polymer of carboxyl group-containing nitrile rubber with tetra-n-butoxy titanium. Nitrile rubber has a high dielectric constant. A large displacement amount of the dielectric layer 21 can therefore be implemented even if the applied voltage is relatively low. Moreover, the use of tetra-n-butoxy titanium as a metal alkoxide compound facilitates the crosslinking reaction with the rubber polymer.

The dielectric layer 21 contains an inorganic substance (titania) that is produced by a reaction between the rubber polymer and tetra-n-butoxy titanium. Since the inorganic substance blocks a flow of electrons, the dielectric layer 21 has high insulation properties. Moreover, the dielectric layer 21 has high strength as it contains the inorganic substance. Accordingly, the dielectric layer 21 is less likely to creep and has high durability. The expression display device 1 of the present embodiment can therefore repeatedly display certain expressions for a long period of time. Moreover, since the electrostrictive element 20 has high durability, the life of the device is long. Since the dielectric layer 21 has high strength, the thickness thereof can be reduced. The expression display device 1 of the present embodiment can therefore be driven at a voltage as low as about 1,000V.

The front electrodes 01X to 05X and the back electrodes 01Y to 05Y contain acrylic rubber and carbon black. The front electrodes 01X to 05X and the back electrodes 01Y to 05Y are thus flexible and can extend and contract. The entire expression display device 1 is therefore flexible. Moreover, movement of the dielectric layer 21 is less likely to be restricted by the front electrodes 01X to 05X and the back electrodes 01Y to 05Y. A desired displacement amount can therefore be easily obtained.

The expression display device 1 of the present embodiment includes the cover layer 30. Accordingly, the parts of the face can be easily formed by drawing eyes and a mouth on the cover layer 30. Moreover, the surface of the expression display device 1 can be made to look more like the skin of a human or animal by coloring the cover layer 30. The expression display device 1 can therefore make more real expressions. Moreover, the cover layer 30 is made of silicone rubber having high insulation properties. This can ensure insulation properties against the front electrodes 01X to 05X, which improves safety.

### Second Embodiment

An expression display device of the second embodiment is different from that of the first embodiment in that three electrostrictive elements are disposed so as to correspond to eyes and a mouth. The difference will be mainly described below.

[Configuration of Expression Display Device]

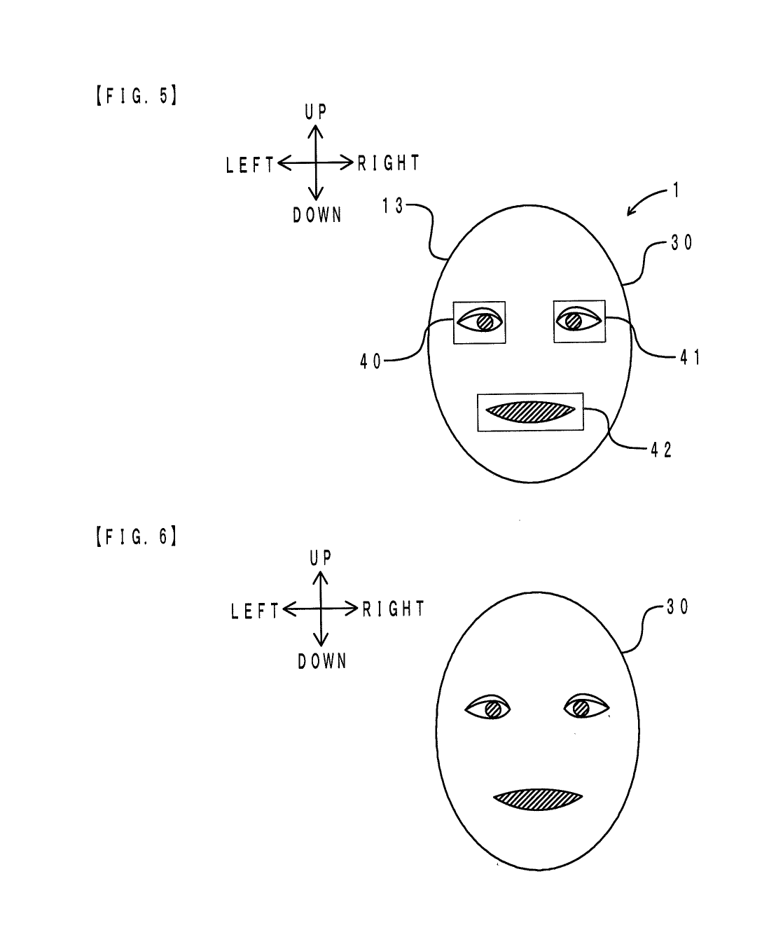

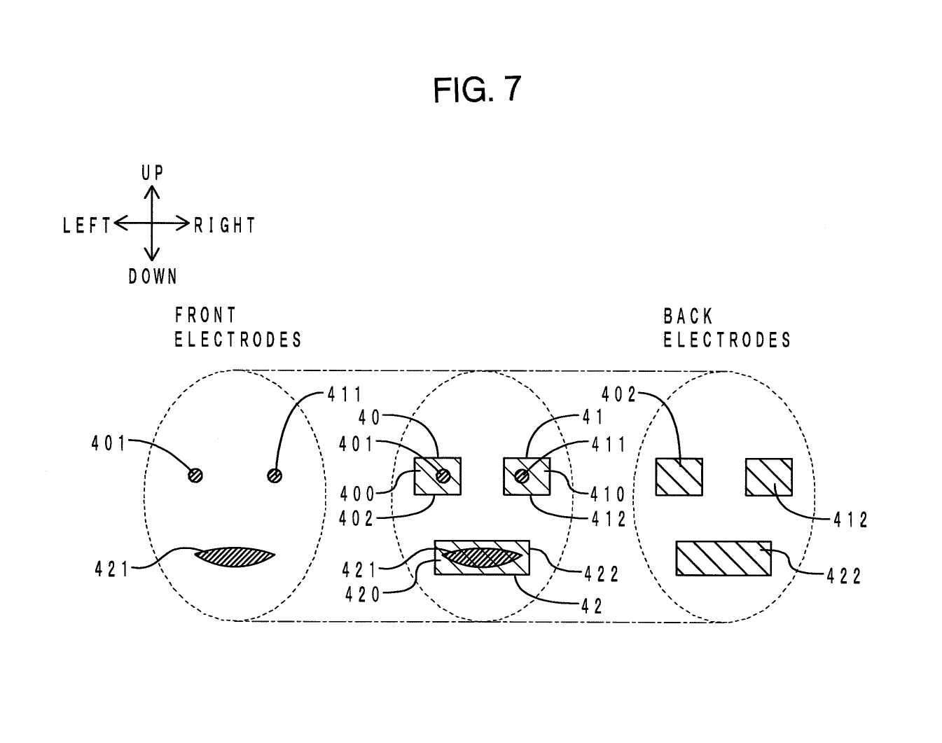

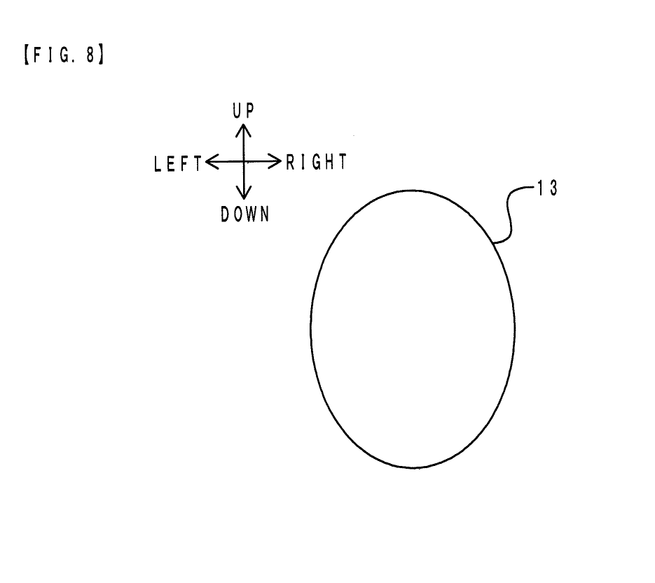

First, the configuration of the expression display device according to the present embodiment will be described. FIG. 5 is a front transparent view of the expression display device of the present embodiment. FIGS. 6 to 8 are plan views sequentially showing members of the expression display device from the front side. That is, FIG. 6 is a front view of a cover layer. FIG. 7 is a front transparent view of electrostrictive elements. FIG. 8 is a front view of a base material. In FIGS. 5 and 7, the members shown transparently are shown by thin lines. Electrodes are shown hatched in FIG. 7. The front surface of the expression display device 1 is a smoothly curved surface having a convex shape. However, for convenience of description, the front surface of the expression display device 1 is shown as a flat surface in FIGS. 5 to 8. As shown in FIGS. 5 to 8, the expression display device 1 includes a base material 13, three electrostrictive elements 40, 41, 42, and a cover layer 30.

As shown in FIG. 8, the base material 13 is made of a resin and is in the shape of an elliptical thin film. The base material 13 is disposed on a face part of a humanoid robot (not shown). The base material 13 is placed so as to cover the entire face part.

As shown in FIG. 7, the three electrostrictive elements 40, 41, 42 are disposed on the front surface of the base material 13. The three electrostrictive elements 40, 41, 42 are sequentially placed at the positions corresponding to a left eye, a right eye, and a mouth. The electrostrictive element 40 placed at the position of the left eye has a dielectric layer 400, a front electrode 401, and a back electrode 402. The electrostrictive element 41 placed at the position of the right eye has a dielectric layer 410, a front electrode 411, and a back electrode 412. The electrostrictive element 42 placed at the position of the mouth has a dielectric layer 420, a front electrode 421, and a back electrode 422. Since the electrostrictive element 40 has the same configuration as the electrostrictive element 41, the electrostrictive element 40 and the electrostrictive element 42 will be described below.

In the electrostrictive element 40, the dielectric layer 400 is in the shape of a rectangular sheet. The dielectric layer 400 has a thickness of 15 μm. The dielectric layer 400 is made of a three-dimensional crosslinked material produced by crosslinking a rubber polymer of carboxyl group-containing hydrogenated nitrile rubber with tetra-n-butoxy zirconium (metal alkoxide compound). That is, the dielectric layer 400 is comprised of only a crosslinked material layer. The dielectric layer 400 is fixed in a stretched state to the base material 13. The degree of stretching of the dielectric layer 400 is 25% in the up-down direction and 50% in the left-right direction.

The front electrode 401 is formed on the front surface (front side) of the dielectric layer 400. The front electrode 401 has a circular shape. The front electrode 401 contains acrylic rubber and carbon black. The front electrode 401 is formed by a bar coating method. The front electrode 401 is connected to a control unit (not shown) via a wire (not shown). The back electrode 402 is formed on the rear surface (back side) of the dielectric layer 400. The back electrode 402 has a rectangular shape. The back electrode 402 has substantially the same size as the dielectric layer 400. The back electrode 402 contains acrylic rubber and carbon black. The back electrode 402 is formed by a bar coating method. The back electrode 402 is connected to the control unit (not shown) via a wire (not shown).

In the electrostrictive element 42, the dielectric layer 420 is in the shape of a rectangular sheet. The dielectric layer 420 has a thickness of 15 μm. The dielectric layer 420 is made of a three-dimensional crosslinked material produced by crosslinking a rubber polymer of carboxyl group-containing hydrogenated nitrile rubber with tetra-n-butoxy zirconium (metal alkoxide compound). That is, the dielectric layer 420 is comprised of only a crosslinked material layer. The dielectric layer 420 is fixed in a stretched state to the base material 13. The degree of stretching of the dielectric layer 420 is 100% in the up-down direction and 200% in the left-right direction.

The front electrode 421 is formed on the front surface of the dielectric layer 420. The front electrode 421 has an elongated elliptical shape. The front electrode 421 contains acrylic rubber and carbon black. The front electrode 421 is formed by a bar coating method. The front electrode 421 is connected to the control unit (not shown) via a wire (not shown). The back electrode 422 is formed on the rear surface of the dielectric layer 420. The back electrode 422 has a rectangular shape. The back electrode 422 has substantially the same size as the dielectric layer 420. The back electrode 422 contains acrylic rubber and carbon black. The back electrode 422 is formed by a bar coating method. The back electrode 422 is connected to the control unit (not shown) via a wire (not shown).

As shown in FIG. 6, the cover layer 30 is disposed so as to cover the front surfaces of the base material 13 and the electrostrictive elements 40, 41, 42. The cover layer 30 is bonded to the front surfaces of the base material 13 and the electrostrictive elements 40, 41, 42. The cover layer 30 is made of silicone rubber colored pale orange, and is in the shape of an elliptical sheet. The cover layer 30 has a thickness of 20 μm. Eyes and a mouth have been drawn on the front surface of the cover layer 30. The front electrodes 401, 411 of the electrostrictive elements 40, 41 have substantially the same size as that of the iris drawn on the cover layer 30. The front electrode 421 of the electrostrictive element 42 has substantially the same size as the mouth drawn on the cover layer 30.

[Movement of Expression Display Device]

Movement of the expression display device 1 of the present embodiment will be described below. For example, in the case of displaying a joyful expression, a voltage of 1,000 V is applied to each of the front electrodes 401, 411, 421 and the back electrodes 402, 412, 422 of the three electrostrictive elements 40, 41, 42. The dielectric layers 400, 410, 420 each interposed between a corresponding one of the front electrodes 401, 411, 421 and a corresponding one of the back electrodes 402, 412, 422 are compressed in the front-rear direction, and are extended in a planar direction. The degree of stretching of the dielectric layers 400, 410 is 25% in the up-down direction and 50% in the left-right direction. The degree of stretching of the dielectric layer 420 is 100% in the up-down direction and 200% in the left-right direction. The dielectric layers 400, 410, 420 are therefore extended to a greater extent in the direction in which the degree of stretching is smaller, namely in the up-down direction. As the dielectric layers 400, 410, 420 are extended, the cover layer 30 is also extended accordingly. The eyes and mouth drawn on the cover layer 30 thus become bigger. A joyful expression is displayed in this manner.

[Functions and Effects]

Functions and effects of the expression display device 1 of the present embodiment will be described below. Regarding the portions having the same configuration as the first embodiment, the expression display device 1 of the present embodiment has functions and effects similar to those of the expression display device 1 of the first embodiment. According to the expression display device 1 of the present embodiment, the eyes and the mouth can be moved independently of each other by controlling a voltage to be applied to each of the three electrostrictive elements 40, 41, 42. Since the electrostrictive elements 40, 41, 42 are placed for each of the corresponding parts to be moved, the displacement amount can be easily adjusted individually for each part. The expression display device 1 of the present embodiment can thus display various expressions.

The degree of stretching of the dielectric layers 400, 410 is different from that of the dielectric layer 420. The displacement amount according to the movement of the eyes and mouth can therefore be implemented even if the same voltage is applied. In each of the dielectric layers 400, 410, 420, the degree of stretching in the up-down direction is different from that in the left-right direction. The dielectric layers 400, 410, 420 are therefore preferentially extended in the direction in which the degree of stretching is smaller (up-down direction). The dielectric layers 400, 410 can thus be made to extend and contract in a manner closer to that in which the eyes move. Similarly, the dielectric layer 420 can be made to extend and contract in a manner closer to that in which the mouth moves. The expression display device 1 can therefore display more natural expressions.

Each of the dielectric layers 400, 410, 420 is made of a three-dimensional crosslinked material produced by crosslinking a rubber polymer of carboxyl group-containing hydrogenated nitrile rubber with tetra-n-butoxy zirconium. Hydrogenated nitrile rubber has a high dielectric constant. A large displacement amount of the dielectric layers 400, 410, 420 can therefore be implemented even if the applied voltage is relatively low. Moreover, the use of tetra-n-butoxy zirconium as a metal alkoxide compound facilitates the crosslinking reaction with the rubber polymer.

The dielectric layers 400, 410, 420 contain an inorganic substance (zirconia) that is produced by a reaction between the rubber polymer and tetra-n-butoxy zirconium. Since the inorganic substance blocks a flow of electrons, the dielectric layers 400, 410, 420 have high insulation properties. Moreover, the dielectric layers 400, 410, 420 have high strength as they contain the inorganic substance. Accordingly, the dielectric layers 400, 410, 420 are less likely to creep and has high durability. The expression display device 1 of the present embodiment can therefore repeatedly display certain expressions for a long period of time. Moreover, since the electrostrictive elements 40, 41, 42 have high durability, the life of the device is long. Since the dielectric layers 400, 410, 420 have high strength, the thickness thereof can be reduced. The expression display device 1 of the present embodiment can therefore be driven at a voltage as low as about 1,000V.

<Others>

The embodiments of the flexible expression display device of the present invention are described above. However, embodiments are not particularly limited to the above embodiments. The present invention can be carried out in various modified or improved forms that may be achieved by those skilled in the art.

In the above embodiments, the dielectric layer of the electrostrictive element is comprised of only a crosslinked material layer made of a three-dimensional crosslinked material. However, the dielectric layer may be a stack of the crosslinked material layer and at least one other layer(s). Examples of the other layer(s) include an elastomer layer made of nitrile rubber, hydrogenated nitrile rubber, acrylic rubber, etc., a high resistance layer containing an elastomer and insulating particles, an ion component-containing layer containing an elastomer and an ion component, and a semiconductor-containing layer containing an elastomer and a semiconductor. There may be either a single other layer or two or more other layers.

Preferred examples of the rubber polymer that forms the crosslinked material layer include acrylic rubber, urethane rubber, fluororubber, fluorosilicone rubber, chlorosulfonated polyethylene rubber, chloroprene rubber, an ethylene-vinyl acetate copolymer, chlorinated polyethylene, hydrin rubber, and polyether rubber in addition to nitrile rubber and hydrogenated nitrile rubber in the above embodiments.

The type of metal alkoxide compound is not particularly limited. For example, the metal alkoxide compound is given by the following general formula (1).

M(OR)ₘ (1)

[In Formula (1), M represents an atom of a metal etc. R represents any one or more of an alkyl group, an aryl group, and an alkenyl group which have 1 to 10 carbon atoms, and Rs may be the same or different from each other. Moreover, m represents the valence of the atom M of a metal etc.]
The metal alkoxide compound may be a multimer having two or more repeating units [(MO)ₙ, where n represents an integer of 2 or more] per molecule. Compatibility with the rubber polymer, the reaction rate, etc. can be adjusted by changing the value n. A preferred multimer can be selected as appropriate according to the type of rubber polymer.

Examples of the atom M of a metal etc. include titanium, zirconium, aluminum, silicon, iron, copper, tin, barium, strontium, hafnium, and boron. In particular, the metal alkoxide compound containing one or more metals selected from titanium, zirconium, and aluminum is desirable as such a metal alkoxide compound has satisfactory reactivity. Specifically, tetra-n-butoxy titanium, tetra-n-butoxy zirconium, tetra-n-butoxy silane, acetoalkoxyaluminum diisopropylate, tetra-i-propoxy titanium, tetraethoxysilane, etc. are preferable.

Examples of a compound having a hydrosilyl group (hydrosilyl compound) include compounds given by the following general formulae (2) to (4). In each formula, repeating units m, n, p, q may be in any form of polymerization such as random polymerization or block polymerization. For example, the compounds given by the general formulae (2) to (4) can be produced by causing a hydrocarbon compound having an alkenyl group to react with a polyhydrosilane compound so that a hydrosilyl group remains in the molecular structure of the resultant reaction product.

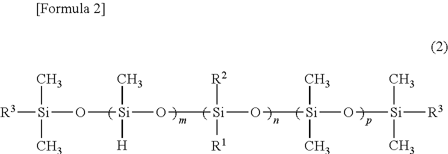

[In the formula, R¹ and R² represent a hydrocarbon group having 1 to 20 carbon atoms. R³ represents a hydrogen atom or a methyl group, and R³s may be the same or different from each other (R³ represents a hydrogen atom when m is 1). Moreover, m represents an integer of 1 or more, n represents an integer of 0 or more, p represents 0 or a positive number, and 2≦m+n+p≦200.]

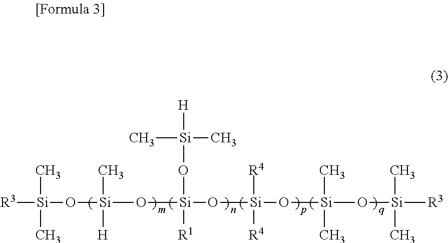

[In the formula, R¹ represents a hydrocarbon group having 2 to 20 carbon atoms. R³ represents a hydrogen atom or a methyl group, and R³s may be the same or different from each other (R³ represents a hydrogen atom when m is 0). R⁴ represents a hydrocarbon group having 1 to 20 carbon atoms, and R⁴s may be the same or different from each other. Moreover, m represents 0 or a positive number, n represents an integer of 0 or more, p represents 0 or a positive number, q represents 0 or a positive number, and 1≦m+n+p+q≦200.]

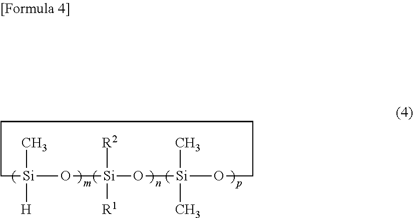

[In the formula, R¹ represents a hydrocarbon group having 2 to 20 carbon atoms, and R² represents a hydrocarbon group having 1 to 20 carbon atoms. Moreover, m represents an integer of 2 or more, n represents an integer of 0 or more, p represents 0 or a positive number, and 3≦m+n+p≦50.]

Among the compounds given by the general formulae (2) to (4), those compounds in which n is an integer of 1 or more are preferable, and in particular, those compounds given by the following structural formulae (5) to (9) are desirable.

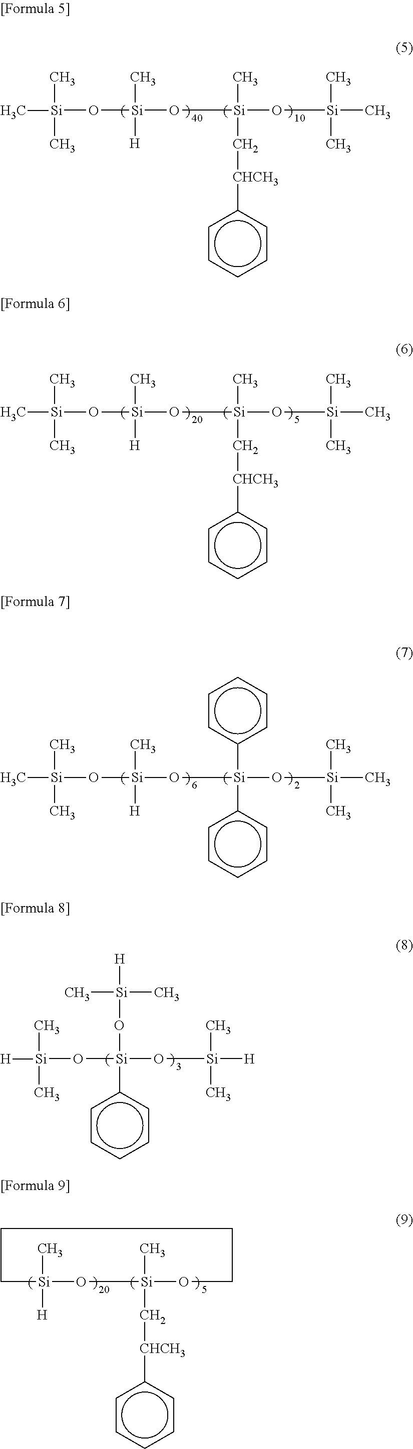

In the case of using a compound having a hydrosilyl group, a hydrosilylation catalyst such as a platinum compound, a palladium compound, a rhodium compound, an iridium compound, or a ruthenium compound can be used as appropriate. Examples of the platinum compound include chloroplatinic acid, a complex of chloroplatinic acid and alcohol, aldehyde, ketone, etc., a platinum-vinyl siloxane complex, a platinum-olefin complex, a platinum-phosphite complex, and solid platinum supported by a carrier such as platinum, alumina, silica, or carbon black.

For example, the three-dimensional crosslinked material (crosslinked material layer) can be produced as follows. In the case of using a metal alkoxide compound, a rubber polymer is first mixed with a metal alkoxide compound in a solvent in which the rubber polymer can be dissolved and which can chelate the metal alkoxide compound. Next, the solvent is removed from the mixed solution of the rubber polymer and the metal alkoxide compound to cause a crosslinking reaction to proceed. In the case of using a compound having a hydrosilyl group, a compound having a hydrosilyl group and as necessary a catalyst etc. are first added to a rubber polymer, and the resultant mixture is kneaded to prepare an elastomer composition. Next, the elastomer composition is dissolved in a solvent to prepare an elastomer solution. Then, the elastomer solution is applied to a base material and crosslinked.

The dielectric layer may be stretched uniformly (at the same degree of stretching) in the planar direction. Alternatively, the dielectric layer may be stretched so that the degree of stretching varies between two directions (longitudinal and lateral directions) perpendicular to each other in the same plane. In either case, the degree of stretching can be set as appropriate in view of the displacement direction and the displacement amount. In the above embodiments, the degree of stretching is varied depending on the part of the face. However, the degree of stretching may be the same regardless of the part of the face.

The electrodes may be any electrodes containing an elastomer and a conductive material. Examples of the elastomer include crosslinked rubber such as silicone rubber, nitrile rubber, an ethylene-propylene-diene copolymer, natural rubber, styrene-butadiene rubber, acrylic rubber, urethane rubber, epichlorohydrin rubber, chlorosulfonated polyethylene, and chlorinated polyethylene, and a thermoplastic elastomer such as a styrene elastomer, an olefin elastomer, a vinyl chloride elastomer, a polyester elastomer, a polyurethane elastomer, and a polyamide elastomer. Alternatively, an elastomer modified by introducing a functional group therein etc. may be used, such as epoxy group-modified acrylic rubber or carboxyl group-modified hydrogenated nitrile rubber.

Examples of the conductive material include conductive carbon powder such as carbon black, carbon nanotube, and graphite, and metal powder such as silver, gold, copper, nickel, rhodium, palladium, chromium, titanium, platinum, iron, and alloys thereof. Alternatively, powder comprised of particles coated with a metal may be used, such as silver-coated copper powder. One of these conductive materials may be used alone, or a mixture of two or more of these conductive materials may be used.

In addition to the elastomer and the conductive material, the electrodes may contain as necessary an additive such as a crosslinking agent, a dispersing agent, a reinforcing agent, a plasticizer, an antioxidant, or a coloring agent. For example, a conductive coating material can be prepared by adding a conductive material and as necessary an additive to a polymer solution produced by dissolving a polymer corresponding to the amount of elastomer in a solvent, and stirring and mixing the resultant solution. The front and back surfaces of the dielectric layer are coated with the prepared conductive coating material to form electrodes. Alternatively, a release film may be coated with the conductive coating material to form electrodes, and the electrodes thus formed may be transferred onto the front and back surfaces of the dielectric layer.

The voltage that is applied to the electrostrictive element can be determined as appropriate in view of the configuration, material, thickness, displacement amount, etc. of the dielectric layer. In the flexible expression display device of the present invention, the electrostrictive element or can be driven at a relatively low voltage. For example, the applied voltage is 1,500 V or less, 1,300 V or less, or 1,000 V or less.

In the above embodiments, the cover layer is placed so as to cover the front surface of the face by including the electrostrictive element. However, the cover layer is not necessarily required. In the case of providing the cover layer, the material, whether the cover layer should be colored or not, the parts or patterns to be drawn on the cover layer, etc. are not particularly limited. An elastomer having high adhesion to a member to be covered, high wear resistance, and high antifouling properties is preferable as a material of the cover layer. Examples of such an elastomer include silicone rubber, acrylic rubber, urethane rubber, polyether rubber, and fluororubber.

The expression display device of the first embodiment has a single electrostrictive element that is disposed over the entire face. In this embodiment, the number of strip-shaped front and back electrodes, the intervals between the front electrodes and between the back electrodes, and the crossing angle between the front and back electrodes are not particularly limited. The shape of the frame etc, is also not particularly limited. The face may be divided into a plurality of regions, and the electrostrictive element of the first embodiment may be disposed in each of the regions.

The expression display device of the second embodiment has three electrostrictive elements each disposed in a different part of the face. In this embodiment, the number of electrostrictive elements, the parts where the electrostrictive elements are placed, etc. are not particularly limited. The shape of the dielectric layers forming the electrostrictive elements, the shape of the electrodes, etc. are also not particularly limited. The base material may be omitted.

### Examples

The electrostrictive element forming the flexible expression display device of the present invention will be specifically described with respect to examples.

<Manufacturing of Electrostrictive Element of Example 1>

A crosslinked material layer made of a three-dimensional crosslinked material synthesized from a rubber polymer and a metal alkoxide compound was produced as a dielectric layer. First, a rubber polymer of carboxyl group-containing nitrile rubber was dissolved in acetylacetone. Tetra-n-butoxy titanium was mixed with the resultant solution. Acetylacetone is a solvent that dissolves the rubber polymer, and is a chelating agent for the metal alkoxide compound. Next, a base material was coated with the mixed solution. The coated base material was dried and then heated at 175° C. for about 30 minutes to produce a crosslinked material layer (corresponding to the dielectric layer 21 of the first embodiment). The crosslinked material layer had a thickness of 15 μm.

Electrodes were manufactured as follows. First, 100 parts by mass of an acrylic rubber polymer (“Nipol (registered trademark) AR42W” made by Zeon Corporation), 1 part by mass of stearic acid (“LUNAC (registered trademark) S30” made by Kao Corporation) as a processing aid, 2.5 parts by mass of zinc dimethyldithiocarbamate (“NOCCELER (registered trademark) PZ” made by OUCHI SHINKO CHEMICAL INDUSTRIAL CO., LTD.) as a vulcanization accelerator, and 0.5 parts by mass of ferric dimethyldithiocarbamate (“NOCCELER TTFE” made by OUCHI SHINKO CHEMICAL INDUSTRIAL CO., LTD.) were mixed in a roll mill to prepare an elastomer composition. Next, the elastomer composition thus prepared was dissolved in 312 parts by mass of ethylene glycol monobutyl ether acetate as a solvent to prepare an elastomer solution. 12 parts by mass of carbon black (“KETJENBLACK (registered trademark) EC-600JD” made by Lion Corporation) as a conductive material was added to the elastomer solution, and the resultant solution was kneaded with three rolls to prepare a conductive coating material. The surface of a base material made of polyethylene terephthalate and subjected to a release treatment was coated with the prepared conductive coating material by a bar coating method. Then, the base material having the coating film formed thereon was left to stand for about 30 minutes in a drying furnace at about 150° C. The coating film was thus dried and a crosslinking reaction was caused to proceed to form electrodes.

The electrodes thus formed were separated from the base material and bonded to the front and back surfaces of the crosslinked material layer (dielectric layer). The electrostrictive element of Example 1 was manufactured in this manner.

<Manufacturing of Electrostrictive Element of Example 2>

A crosslinked material layer made of a three-dimensional crosslinked material synthesized from a rubber polymer and a compound having a hydrosilyl group was produced as a dielectric layer. First, 100 parts by mass of a chloroprene rubber polymer (“Neoprene (registered trademark) W” made by DDE), 5 parts by mass of a hydrosilyl compound, 0.03 parts by mass of acetylene alcohol as a retarder, and 0.1 parts by mass of a platinum catalyst were mixed and dispersed in a roll mill to prepare an elastomer composition. Next, the elastomer composition was dissolved in methyl ethyl ketone to prepare an elastomer solution. Then, a base material was coated with the elastomer solution, and the coated base material was dried and then heated at 150° C. for about 15 minutes to produce a crosslinked material layer. The crosslinked material layer had a thickness of 20 μm. A compound given by the above structural formula (5) was used as the hydrosilyl compound.

Electrodes similar to those of Example 1 were bonded to the front and back surfaces of the produced crosslinked material layer (dielectric layer). An electrostrictive element of Example 2 was thus manufactured.

<Manufacturing of Electrostrictive Element of Comparative Example>

An electrostrictive element of a comparative example was manufactured in a manner similar to that of Example 1 except that an acrylic foam structural bonding tape (“VHB (registered trademark) 4910”) made by 3M was used as a dielectric layer.

<Evaluation of Electrostrictive Elements>

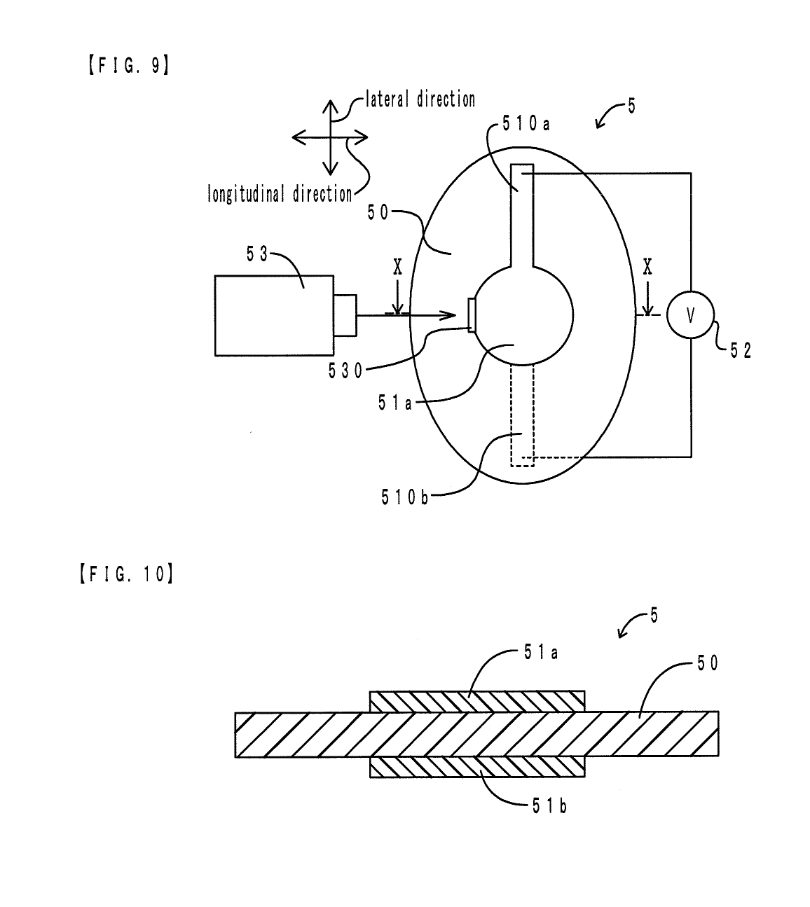

The manufactured electrostrictive elements of Examples 1, 2 and the comparative example were evaluated in terms of the displacement amount and durability. First, an experimental apparatus and an experimental method will be described. FIG. 9 is a top view of a manufactured electrostrictive element. FIG. 10 is a sectional view taken along line X-X in FIG. 9.

As shown in FIGS. 9 and 10, an electrostrictive element 5 includes a dielectric layer 50 and a pair of electrodes 51a, 51b. The dielectric layer 50 is in the shape of a circular thin film with a diameter of 70 mm in a natural state before extension. The dielectric layer 50 is disposed in a stretched state at a predetermined degree of stretching. The degree of stretching of the electrostrictive element of Example 1 was 25% in the longitudinal direction and 50% in the lateral direction. The degree of stretching of the electrostrictive element of Example 2 was 50% in the longitudinal direction and 100% in the lateral direction. The degree of stretching of the electrostrictive element of the comparative example was 100% in the longitudinal direction and 200% in the lateral direction. The degree of stretching is a value calculated by the following expression (I).

Degree of stretching (%)=(L₁−L₀)/L₀×100 (I)

[L₀: length before extension (natural state), L₁: length after extension]

The pair of electrodes 51a, 51b are disposed so as to face each other in the up-down direction with the dielectric layer 50 interposed therebetween. The electrodes 51a, 51b are in the shape of a circular thin film with a diameter of about 27 mm, and are disposed substantially concentrically with the dielectric layer 50. The electrode 51a has a terminal portion 510a formed at its outer peripheral edge so as to protrude radially outward. The terminal portion 510a is in the shape of a rectangular plate. Similarly, the electrode 51b has a terminal portion 510b formed at its outer peripheral edge so as to protrude radially outward. The terminal portion 510b is in the shape of a rectangular plate. The terminal portion 510b is disposed at a position shifted by 180° from the terminal portion 510a so as to face the terminal portion 510a. The terminal portions 510a, 510b contain urethane rubber and silver powder. Each of the terminal portions 510a, 510b is connected to a power supply 52 via a wire (not shown).

When a voltage is applied between the electrodes 51a, 51b, electrostatic attraction is generated between the electrodes 51a, 51b, compressing the dielectric layer 50. The dielectric layer 50 is thus reduced in thickness, and is extended in the longitudinal direction in which the degree of stretching is small. At this time, the electrodes 51a, 51b are also extended together with the dielectric layer 50. The electrode 51a has a marker 530 attached thereto. Displacement of the marker 530 in response to the voltage application was measured by a displacement meter 53 as the displacement amount of the electrostrictive element 5. The applied voltage was 1,250V for the electrostrictive element of Example 1, 1,000V for the electrostrictive element of Example 2, and 2,500 V for the electrostrictive element of the comparative example. The displacement rate was calculated by the following expression (II).

Displacement rate (%)=(displacement amount/radius of electrode)×100 (II)

After the displacement amount of the electrostrictive element 5 was measured, the electrostrictive element 5 was left for a predetermined period (3 days, 7 days, and 30 days) with no voltage application (with the dielectric layer 50 kept stretched). After each of the above periods passed, the same voltage as that applied initially was applied again, and the displacement amount of the electrostrictive element 5 was measured. Durability of the electrostrictive element 5 was evaluated as acceptable (shown by 0 in Table 1 below) if the decrease in displacement amount from the initially measured displacement amount was less than 40%. Durability of the electrostrictive element 5 was evaluated as unacceptable (shown by x in Table 1 below) if the decrease in displacement amount from the initially measured displacement amount was 40% or more.

Table 1 shows the measurement result of the displacement amount and the durability evaluation result of the electrostrictive elements of Examples 1, 2 and the comparative example.

TABLE 1

| | | | | | Compar- |
|---|---|---|---|---|---|
| | | | Ex- | Ex- | ative Ex- |
| | | | ample 1 | ample 2 | ample |
| Dielectric | Thickness [μm] | | 15 | 20 | 500 |
| Layer | Degree of | Longitudinal | 25 | 50 | 100 |
| | Stretching [%] | Lateral | 50 | 100 | 200 |

| Applied Voltage [V] | | 1250 | 1000 | 2500 |
|---|---|---|---|---|
| Displacement Rate [%] | | 25 | 23 | 22.5 |
| Durability | After 3 days | ◯ | ◯ | ◯ |
| Evaluation | After 7 days | ◯ | ◯ | X |
| | After 30 days | ◯ | ◯ | X |

As shown in Table 1, in the electrostrictive elements of Examples 1, 2, the dielectric layer has a smaller thickness as compared to the electrostrictive element of the comparative example. In the electrostrictive elements of Examples 1, 2, a larger displacement amount was obtained at a lower voltage as compared to the electrostrictive element of the comparative example even though the degree of stretching was smaller. In the electrostrictive elements of Examples 1, 2, the decrease in displacement amount was small even after 30 days, and it was thus verified that the electrostrictive elements of Examples 1, 2 had high durability. In the electrostrictive element of the comparative example, the dielectric layer has a large thickness. In order to obtain a desired displacement amount, it was required to increase the degree of stretching of the dielectric layer and the applied voltage. Accordingly, after 7 days and after 30 days, the dielectric layer crept and the decrease in displacement amount was 40% or more.

The electrostrictive element forming the flexible expression display device of the present invention can thus implement a large displacement amount even if the degree of stretching of the dielectric layer is small and the electrostrictive element is driven by a relatively low voltage of 1,500 V or less. The dielectric layer is less likely to creep and has high durability. The flexible expression display device of the present invention can therefore repeatedly display certain expressions for a long period of time. Moreover, since the electrostrictive element has high durability, the life of the device is long.

1. A flexible expression display device, characterized by comprising:
an electrostrictive element having a stretched dielectric layer, and electrodes disposed with the dielectric layer interposed therebetween, wherein
the dielectric layer has a crosslinked material layer made of a three-dimensional crosslinked material synthesized from a rubber polymer and a metal alkoxide compound or a compound having a hydrosilyl group,
the electrodes contain an elastomer and a conductive material, and
the flexible expression display device displays a facial expression as the dielectric layer extends and contracts according to a voltage that is applied between the electrodes.

2. The flexible expression display device according to claim 1, wherein
the dielectric layer is disposed in a stretched state over a part of or an entire face, and
the electrodes are comprised of front electrodes arranged in a plurality of lines on a front surface of the dielectric layer and back electrodes arranged in a plurality of lines on a back surface of the dielectric layer, and the front electrodes cross the back electrodes as viewed in a front-back direction to form a plurality of drive units.

3. The flexible expression display device according to claim 2, wherein
a degree of stretching of the dielectric layer varies in each part of the face.

4. The flexible expression display device according to claim 1, wherein
at least one electrostrictive element is disposed so as to correspond to a part of a face.

5. The flexible expression display device according to claim 4, wherein
a plurality of the electrostrictive elements are disposed so as to correspond to parts of the face, and the degree of stretching of the dielectric layer varies in each electrostrictive element.

6. The flexible expression display device according to claim 1, wherein
the degree of stretching of the dielectric layer varies between two directions perpendicular to each other in a same plane.

7. The flexible expression display device according to claim 1, further comprising:
a cover layer that covers the electrostrictive element and that can extend and contract.

8. The flexible expression display device according to claim 1, wherein
the voltage that is applied between the electrodes is 1,500 V or less.

9. The flexible expression display device according to claim 1, wherein
the rubber polymer is one or more selected from nitrile rubber, hydrogenated nitrile rubber, acrylic rubber, urethane rubber, fluororubber, fluorosilicone rubber, chlorosulfonated polyethylene rubber, chloroprene rubber, an ethylene-vinyl acetate copolymer, chlorinated polyethylene, hydrin rubber, and polyether rubber.

10. The flexible expression display device according to claim 1, wherein
the crosslinked material layer is made of the three-dimensional crosslinked material synthesized from the rubber polymer and the metal alkoxide compound.

11. The flexible expression display device according to claim 1, wherein
the metal alkoxide compound contains one or more metals selected from titanium, zirconium, and aluminum.

12. The flexible expression display device according to claim 1, wherein
the compound having the hydrosilyl group further has one or more of a phenyl group, an aryl group, and an alkyl group.
